(19) United States
(12) Patent Application Publication
(10) Pub. No.: US 2019/0381673 A1
(43) Pub. Date: Dec. 19, 2019

(54) GUIDE ROBOT

(71) Applicant: LG ELECTRONICS INC., Seoul (KR)

(72) Inventors: Iljae LEE, Seoul (KR); Dooil BYUN, Seoul (KR)

(73) Assignee: LG ELECTRONICS INC.

(21) Appl. No.: 16/439,987

(22) Filed: Jun. 13, 2019

(30) Foreign Application Priority Data
Jun. 15, 2018 (KR) 10-2018-0069116

(51) Int. Cl. B25J 11/00; B25J 9/16; B25J 5/00; B25J 19/02; B25J 19/04; G01S 17/93; B25J 9/12

(52) U.S. Cl. CPC B25J 11/008; B25J 9/1697; B25J 5/007; B25J 9/1666; B25J 9/126; B25J 19/022; B25J 19/023; B25J 19/04; G01S 17/93; B25J 19/026

(57) ABSTRACT

A guide robot includes a base, a body attached above the base, and a head attached above the body, wherein the base, the body, and the head each include a first case configured to form a first face, a second case configured to form a second face, and a bridge case inserted at a point where the first case and the second case are coupled to each other.

### CROSS-REFERENCE TO RELATED APPLICATION(S)

The present application claims priority under 35 U.S.C. 119 and 35 U.S.C. 365 to Korean Patent Application No. 10-2018-0069116, filed in Korea on Jun. 15, 2018 which is hereby incorporated by reference in its entirety.

### BACKGROUND

### 1. Field

A guide robot is disclosed herein.

### 2. Background

Application fields of robots may be classified into industrial, medical, space, and submarine applications. For example, in the mechanical processing industry such as automobile production, robots can perform repetitive tasks. In other words, many industrial robots that repeat the same operation for hours when having learned tasks done by human arms only once have been already in operation.

Generally, a service provided by the robot may vary according to places, users, purposes, and the like. On the other hand, the operation performed by the robot for the service itself is generally to perform a transfer motion in accordance with the speed, travel time, and distance of a specification while enduring a specified load.

With the recent explosive increase in airport users and efforts to make a leap to smart airports, plans have been developed to provide services through robots in airports. When an artificial intelligent robot is introduced to airports, the robots may perform the unique role of a human who could not be replaced by an existing computer system, thereby contributing to the quantitative and qualitative improvement of provided services.

Demands for robots capable of providing convenience to users or replacing the roles of human beings have been rapidly increasing in not only at the airport but also throughout social facilities such as hotels, hospitals, schools, large shopping facilities, cultural facilities, and public facilities.

In this regard, information on the related art document is as follows, whose disclosure is hereby incorporated by reference in its entirety. 1. Korean Registration Number, 10-1193610 (Registration date, Oct. 16, 2012). Title of invention: Crosswalk Traffic Guide Intelligent Robot System.

On the other hand, since the guide robot assists the convenience of the human being, ergonomic, human-friendly, and beautiful designs may be required.

Further, since the guide robot is equipped with a plurality of electronic equipment, it may be required to comply with rules for waterproof, dustproof, and electromagnetic interference (EMI). In addition, the guide robot should be able to prepare various scenarios for safety accidents and prevent the safety accidents for the safety of the user.

However, related art guide robots have a problem that the manageability of the guide robot, such as repair, parts replacement, and transportation are scarified in order to have design elements. In addition, the conventional guide robot is not friendly to the human body due to a large number of fastening holes exposed to the outside, and causes a sense of heterogeneity, resulting in a problem that intimacy with the user is lowered.

### BRIEF DESCRIPTION OF THE DRAWINGS

Embodiments will be described in detail with reference to the following drawings in which like reference numerals refer to like elements and, wherein:

FIG. 1 illustrates an appearance of a guide robot according to an embodiment of the present disclosure;

FIG. 2 illustrates a head part according to an embodiment;

FIG. 3 illustrates the head part in which a bridge case of FIG. 2 is disassembled;

FIG. 4 illustrates a bridge case of a head part according to an embodiment;

FIG. 5 illustrates a configuration of a coupling device of a head part according to an embodiment;

FIG. 6 illustrates a driving part according to an embodiment;

FIG. 7 illustrates the driving part in which a bridge case of FIG. 6 is disassembled;

FIG. 8 illustrates a bridge case of a driving part according to an embodiment;

FIG. 9 is an enlarged view of a portion ‘A’ in FIG. 1;

FIG. 10 is an exploded view of a bridge case of a body part according to an embodiment;

FIG. 11 illustrates a bridge case of a body part according to an embodiment; and

FIG. 12 is an enlarged view of a portion ‘B’ in FIG. 11.

### DETAILED DESCRIPTION

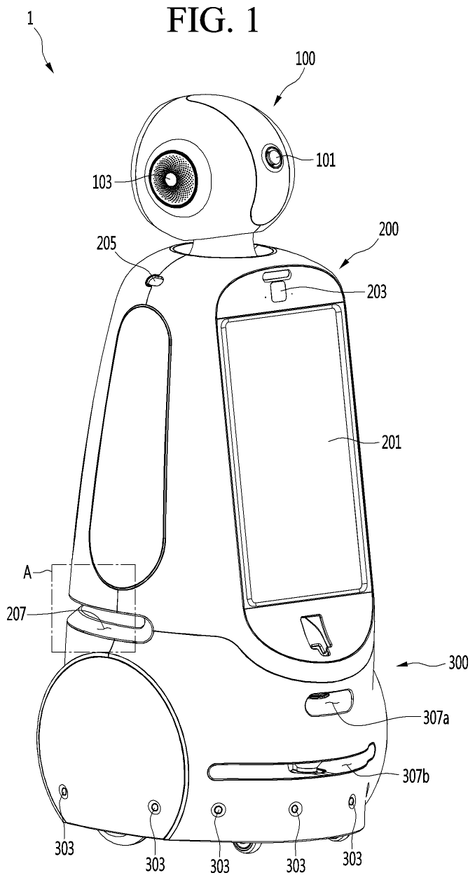

Referring to FIG. 1, a guide robot 1 according to an embodiment of the present disclosure may include a head part (or head) 100 disposed at the uppermost position, a body part (or body) 200 disposed under the head part 100, and a driving part (or base) 300 disposed under the body part 200. The guide robot 1 may be composed of the head part 100, the body part 200 and the driving part 300, and may form an appearance similar to a human body.

The head part 100 may be coupled to a frame extending upward from the inside of the body part 200. Here, the frame engaged with the head part may form a neck-like appearance of the guide robot 1. The body part 200 may be coupled to be seated on the upper surface of the driving part 300.

The head part 100 may include a head display installed on the front surface to provide information while facing a user, speakers 103 for providing voice, and an emergency button 101 for performing emergency braking in an emergency. The speakers 103 may be arranged on both sides of the head part 100 for a human-friendly design. The speakers 103 may be positioned at ear portions of the head part 100.

The speakers 103 may inform the user of airport related information by voice. The emergency button 101 may immediately stop operation of the guide robot 1 while the guide robot 1 is stopping or traveling. For example, the emergency button 101 may cut off an entire power source of the guide robot 1 when being pressed in an emergency situation.

The emergency button 101 may be provided on the rear side of the head display. In addition, the head part 100 may be rotatably installed to face the user when a position of a user is recognized.

The head part 100 may include a sensor for acquiring a person's position or a face image. As an example, the sensor may include an RGBD (Red, Green, Blue, Distance) sensor. The body part 200 may include a display part (or display) 201 embedded in the rear surface of the body part 200, a barcode reader 203 positioned above the display part 201, and a shoulder camera 205 which looks around surroundings at a shoulder part of the guide robot 1.

The display part 201 may be embedded in the rear surface of the guide robot 1. The display part 201 may be formed to elongate vertically on the rear surface of the body part 200. The display part 201 may be installed on the rear surface opposite to the traveling direction to provide a function of guiding a boarding gate and the like to a user.

The display part 201 may include a flat display. The display may perform a function of outputting visual information (e.g., airport gate inquiry information or route guidance service information.) related to a service currently being provided. A user may see the display part 201 mounted on the rear portion of the guide robot 1 while moving along the guide robot 1. Accordingly, various airport information may be provided to the user through the display part 201.

The barcode reader 203 may scan or recognize barcodes provided from, for example, a user's passport, an airline ticket, or via mobile. Information obtained through the barcode reader 203 may be displayed on the display part 201. For example, the user may position a mobile screen or a barcode portion to face a screen of the barcode reader 203. When the barcode reader 203 detects the barcode of the mobile screen, the display part 201 may display and guide a boarding gate to which the user is to move based on the information obtained through the barcode.

The shoulder camera 205 may photograph surroundings and identify a current position of the guide robot 1. For example, the shoulder camera 205 may include a 2D camera for recognizing a person or object based on a two-dimensional image.

The shoulder camera 205 may also obtain a stereoscopic image, and measure a distance between the guide robot 1 and an obstacle through the obtained stereoscopic image. The shoulder camera 205 may detect a collision between the guide robot 1 and an obstacle.

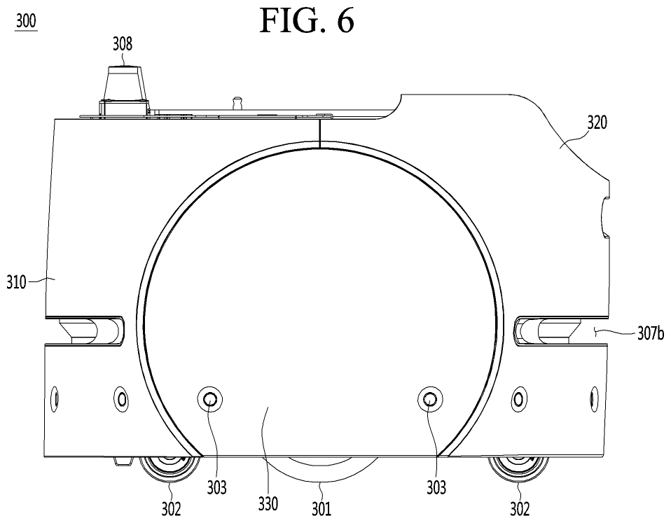

Also, the body part 200 may further include a front light imaging, detection, and ranging (Lidar) groove 207 formed by cutting a lower end of the body part 200 such that operation of the front Lidar 308 (see FIG. 6) is correctly performed. The front Lidar groove 207 may be formed at a lower end of a front surface of the body part 200. For example, the front Lidar groove 207 may be formed by cutting a lower front end of the body part 200 so as to form a semicircular arc.

The front Lidar 308 may be exposed to the outside by the front Lidar groove 207. The front Lidar 308 may perform position recognition by irradiating a laser beam and collecting and analyzing backscattered light among light absorbed or scattered by the aerosol.

The driving part 300 may perform traveling of the guide robot 1 by providing a driving force. The driving part 300 may include a plurality of detection sensors 303 and a plurality of wheels 301 and 302 performing a rolling motion. The plurality of detection sensors 303 may include an ultrasonic sensor 303.

The ultrasonic sensor 303 may sense a distance between an obstacle and the guide robot 1 using an ultrasonic signal. The plurality of wheels may include a main wheel 301 connected to a motor to perform rolling motion according to the driving of the motor, and a an auxiliary wheel 302 not connected to a separate driving device to be dependent on the movement of the main wheel 301 or roll by an external force.

The driving part 300 may further include a plurality of rear Lidar grooves 307a and 307b formed by cutting the rear portion of the driving part 200 such that the operation of a rear Lidar is correctly performed. The rear Lidar grooves 307a and 307b may be formed in the rear surface of the driving part 200. The normal backward Lidar groove may include a rear tilt Lidar groove 307a disposed at a relatively higher position and formed to be inclined by cutting and a rear cut Lidar groove 307b disposed at a relatively lower position and formed by cutting. For example, the rear tilt Lidar groove 307b may be formed by cutting the rear surface of the driving part 300 so as to form a half circle arc.

The rear Lidar may be exposed to the outside by the Lidar grooves 307a and 307b. Like the front Lidar 308, the rear Lidar may perform position recognition by irradiating a laser beam and collecting and analyzing backscattered light among light absorbed or scattered by the aerosol.

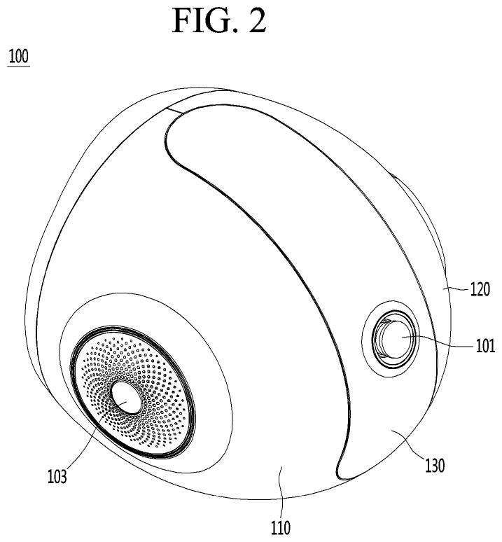

Referring to FIG. 2, the head part 100 may have a hemispherical shape with a flat surface in the front surface thereof. In other words, the head part 100 may be formed in a circular shape to be rounded toward the rear. The head part 100 may include a first head case 110 forming one side of an appearance, a second head case 120 forming the other side of the appearance, and a head bridge case 130 connecting the first head case 110 and the second head case 120.

The first head case 110 and the second head case 120 may be connected such that the upper ends and the lower ends thereof abut against each other, respectively. The first head case 110 and the second head case 120 may be cut such that a central portion extending from the upper end to the lower end is recessed in an inward direction thereof.

The head bridge case 130 may be detachably installed in a center space formed by cutting the first head case 111 and the second head case 120, respectively. Accordingly, the head bridge case 130 may be in contact with the first head case 110 along a first side end, and may be in contact with the second head case 120 along a second side end. Therefore, the head bridge case 130 may be shape-engaged between the first head case 110 and the second head case 120.

The first head case 110 and the second head case 120 may each have a seating surface formed to be recessed such that the head bridge case 130 is seated along inner cut lines thereof. The head bridge case 130 may be seated on the seating surface, enabling the head part 100 to have a smooth and elegant appearance in an integral shape.

The emergency button 101 may be located in the head bridge case 130. The speakers 103 may be positioned in the first head case 110 and the second head case 120, respectively. The first head case 110, the second head case 120, and the head bridge case 130 may be coupled to form an integral shape, providing a smooth outer peripheral surface.

Since holes or pores for fastening a plurality of components are not exposed on the outer peripheral surface of the head part 100, the appearance may be beautiful and human-friendly. The first head case 110, the second head case 120, and the head bridge case 130 may be fixed and coupled stably without a fastening hole exposed on the outer peripheral surface of the head part 100 or a fastening member inserted into the fastening hole.

Hereinafter, there will be given a description for a structure of allowing the cases 110, 120, or 130 constituting the appearance of the head part 100 to be stably fixed and coupled to each other even when the fastening hole or fastening member causing sense of difference is not exposed on the outer peripheral surface of the head part 100.

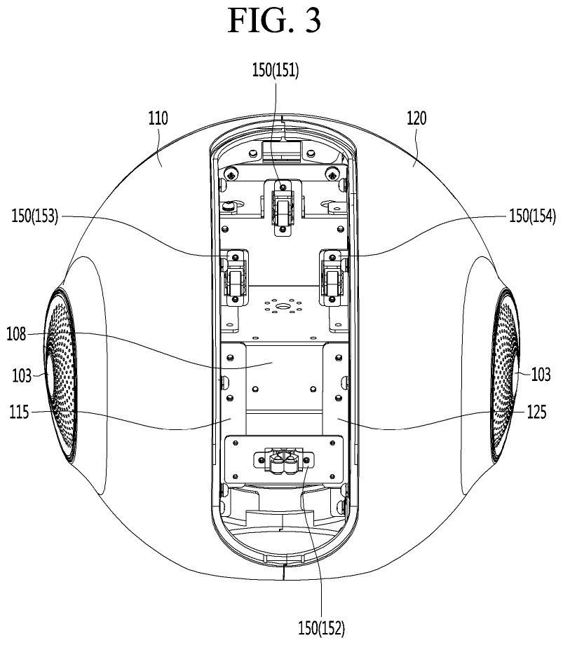

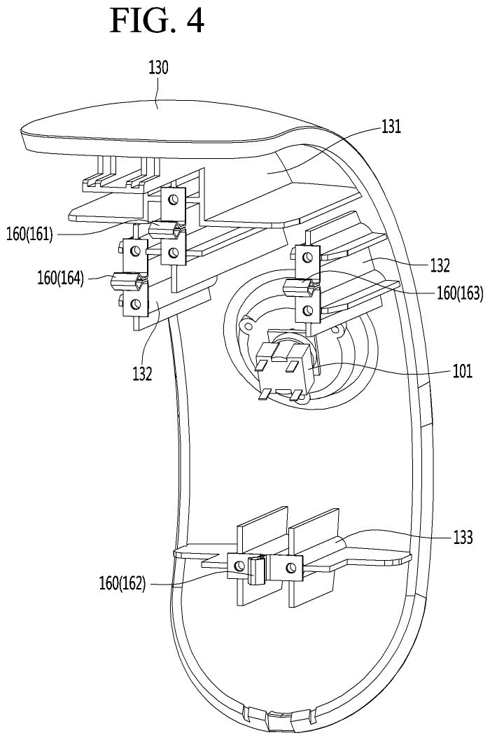

Referring to FIGS. 3 and 4, the head bridge case 130 may be detachably attached to a central portion formed by the first head case 110 and the second head case 120. In the inner space of the head part 100, a plurality of inner cases 115, 108, and 125 capable of managing electromagnetic interference (EMI) caused by a plurality of electronic parts may be located.

The head part 100 may further include a first head inner case 115 coupled to an inner cut end of the first head case 110, a second head inner case 125 coupled to an inner cut end of the second head case 120, and a head connector case 108 connecting the first head inner case 115 and the second head inner case 125 to each other. The first head inner case 115, the second head inner case 125 and the head connector case 108 may be provided in a cut space formed by connecting the first head case 110 and the second head case 120 to each other.

The first head inner case 115 may extend perpendicularly in the inner direction of the head part 100 along a center cut end of the first head case 110 and may be fastened to the first head case 110 by a plurality of fastening members. The second head inner case 125 may extend perpendicularly in the inner direction of the head part 100 along a center cut end of the second head case 120 and may be fastened to the second head case 120 by a plurality of fastening members.

The head connector case 108 may be perpendicular to the first head inner case 115 and the second head inner case 125. A first side of the head connector case 108 may be fastened to the first head inner case 115 and a second side thereof may be fastened to the second head inner case 125.

The first head inner case 115 and the second head inner case 125 may form guide surfaces that extend perpendicularly from the inner surfaces thereof to be engaged with the head connector case 108. In addition, the head connector case 108 may be a bent surface that is vertically bent many times in the inner direction (‘the front’ in FIG. 3) of the head part 100 toward the upward direction. When the head bridge case 130 is mounted on the bent surface, the head extensions 131, 132, and 133 provided in the head bridge case 130 may be seated on the bent surface.

The plurality of inner cases 115, 108 and 125 for managing the electromagnetic interference (EMI) and the plurality of fastening holes and fastening members for guiding the coupling of the inner cases 115, 108 and 125 may be covered by the head bridge case 130 so as not to be exposed to the outside. The head part 100 may further include a plurality of catchers (or roller catches) 150 for guiding the attachment/detachment of the head bridge case 130.

The plurality of catchers 150 may be installed in the plurality of inner cases 115, 108, and 125. The plurality of catchers 150 may include an upper catcher 151, a lower catcher 152, a first side catcher 153, and a second side catcher 154. The upper catcher 151 may be positioned on the upper side of the head connector case 108. The lower catcher 152 may be positioned in the lower side of the head connector case 108.

The upper catcher 151 may be directed toward the central space formed by the first head inner case 115 and the second head inner case 125 at a position where the bent surface is formed and, therefore, may be positioned further in the inner direction than the lower catcher 152. The lower catcher 152 may be provided such that a catcher protrusion (or strike) 160 of the head bridge case 130, which will be described later, may be inserted in the horizontal direction.

The first side catcher 153 and the second side catcher 154 may be symmetric with respect to the first head inner case 115 and the second head inner case 125, respectively. The head part 100 may further include a plurality of catcher protrusions 160 configured to be inserted into the plurality of catchers 150. The plurality of catcher protrusions 160 may be installed in the head bridge case 130.

The plurality of catcher protrusions 160 may be positioned so as to correspond one-to-one with the plurality of catchers 150. Accordingly, the plurality of catcher protrusions 160 may be spaced apart from each other in the vertical direction.

The catcher protrusion 160 may form a protrusion protruding forward. As an example, the protrusion may have a rectangular shape. The catcher protrusion 160 may also be formed with a protrusion protruding forward by bending a single plate a plurality of times and both side surfaces guiding coupling backward. The both side surfaces may be coupled to head extensions 131, 132 and 133 to be described later, and the protrusion at the front may be inserted into the catcher 150.

The plurality of catcher protrusions 160 may include an upper catcher protrusion 161, a lower catcher protrusion 162, a first side catcher protrusion 163 and a second side catcher protrusion 164. A detailed description thereof will be given later.

The head bridge case 130 may be shape-engaged with a cut space at the central portion formed by the first head case 110 and the second head case 120 (hereinafter referred to as a ‘cut space’). The head bridge case 130 may have a predetermined curvature in the vertical direction. The head bridge case 130 may be curved. Since no hole or no pore for fastening is formed in the outer peripheral surface of the head bridge case 130, a smooth surface may be formed.

A hole may be formed in a central portion of the head bridge case 130 such that the emergency button 101 is installed. That is, the emergency button 101 may be positioned in the central portion of the head bridge case 130.

The head bridge case 130 may include a plurality of head extensions 131, 132, and 133 extending from the inner surface. The plurality of head extensions 131, 132, and 133 may extend forward from the inner surface of the head bridge case 130. For example, the head extensions 131, 132, and 133 may include a plate extending in a cross shape.

The plurality of head extensions 131, 132, and 133 may guide the head bridge case 130 to be inserted into the cut space. For example, the plurality of head extensions 131, 132, and 133 may abut against the first head inner case 115 and the second head inner case 125, both ends of which may be located in the cut-out space. Accordingly, the plurality of head extensions 131, 132, and 133 may be inserted into the cutout space slidably along the inner surfaces of the first head inner case 115 and the second head inner case 125.

The plurality of head extensions 131, 132, and 133 may extend to positions corresponding to the plurality of catchers 150. For example, the plurality of head extensions 131, 132, and 133 may extend to a corresponding height and length toward the plurality of catchers 150. The plurality of head extensions 131, 132, and 133 may be placed at different positions in the vertical direction and may have different extension lengths in the forward direction depending on positions at which the plurality of catchers 150 are installed.

The plurality of catcher protrusions 160 may be installed in the plurality of head extensions 131, 132, and 133, respectively. The plurality of catcher protrusions 160 may be positioned on the front surfaces of the plurality of head extensions 131, 132, and 133. Accordingly, the plurality of catcher protrusions 160 may be individually positioned to correspond one to one with the plurality of catchers 150.

The plurality of head extensions 131, 132, and 133 may include an upper head extension 131, a side head extension 132, and a lower head extension 133. The upper catch protrusion 161 may be installed on the front surface of the upper head extension 131. The upper catcher protrusion 161 may be inserted into and engaged with the upper catcher 150 when the head bridge case 130 is installed in the cut-out space.

The lower catcher protrusion 162 may be installed on the front surface of the lower head extension 133. The lower catcher protrusion 162 may be inserted into and engaged with the lower catcher 152 when the head bridge case 130 is installed in the cut-out space.

The side head extension 132 may include a first side head extension and a second side head extension to correspond to the first side catcher 153 and the second side catcher 154. The first side catch protrusion 163 may be installed on the front surface of the first side head extension. The second side catch protrusion 164 may be installed on the front surface of the second side head extension. Therefore, the first side catcher protrusion 163 may be inserted into and engaged with the first side catcher 153 and the second side catcher protrusion 164 may be inserted into and engaged with the second side catcher 154 when the head bridge case 130 is installed in the cut-out space.

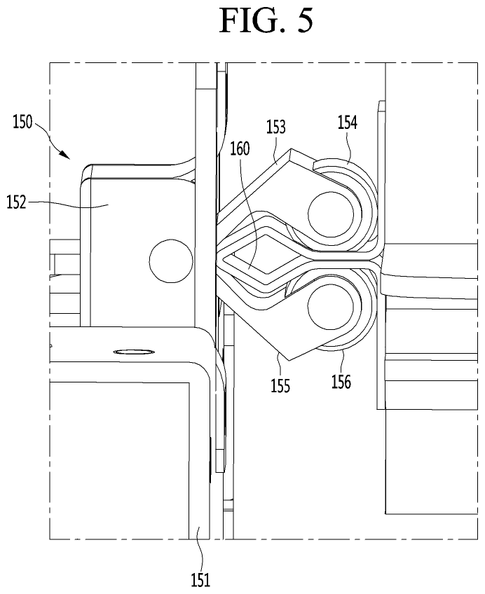

Referring to FIG. 5, the catcher 150 may include a catcher bracket 151 providing a support portion, a roller fixing portion or housing 152 coupled to the catcher bracket 151, roller guides 153 and 155 coupled to the roller fixing portion 152, and rollers 154 and 156 coupled to the roller guides 153 and 155 to allow rolling motion. The catcher bracket 151 may be a fixing portion that stably couples and fixes the catcher 150. For example, the catcher bracket 151 may be coupled to the plurality of inner cases 108, 115, and 125.

The catcher bracket 151 may form an opening into which the roller fixing portion 152 is inserted, in the central portion. The catcher bracket 151 may include an extended surface that guides engagement with the plurality of inner cases 108, 115, and 125 in both lateral directions of the opening.

The roller fixing portion 152 may be inserted into and engaged with the central portion of the catcher bracket 151. The roller fixing portion 152 may be open in one direction. For example, the roller fixing portion 152 may have a hexahedral shape having a rear surface formed as an opening.

The roller guides 153 and 155 may be positioned by passing through the open rear surface of the roller fixing portion 152. The roller guides 153 and 155 may be coupled to both sides of the roller fixing portion 152. For example, the roller guides 153 and 155 may be coupled with a shaft that penetrates both sides of the roller fixing portion 152. The roller guides 153 and 155 may include a first roller guide 153 and a second roller guide 155 extending in the vertical direction so as to have a predetermined angle.

The first roller guide 153 may extend upward along the opening direction of the roller fixing portion 152. The second roller guide 155 may extend downward along the opening direction of the roller fixing portion 152.

The first roller guide 153 and the second roller guide 154 may be symmetrical to each other. The first roller guide 153 and the second roller guide 154 may extend in both directions at a position(shaft) at which they are inserted in the roller fixing portion 152 so as to be symmetrical to each other.

A tip end of the first roller guide 153 may be spaced apart from a tip end of the second roller guide 155. The catcher protrusion 160 may be inserted into a space between the tip end of the first roller guide 153 and the tip end of the second roller guide 155. The roller guides 153 and 155 may be elastically deformable. For example, the first roller guide 153 and the second roller guide 155 may be elastically deformed such that an inner spacing space between the first roller guide 153 and the second roller guide 155 is widened or reduced.

When the catcher projection 160 is inserted into the roller guides 153 and 155, the first roller guide 153 and the second roller guide 155 may be elastically deformed in directions away from each other to guide insertion of the catcher protrusion 160 and when the catcher protrusion 160 is completely inserted, the first roller guide 153 and the second roller guide 155 are elastically restored in directions in which the first roller guide 153 and the second roller guide 155 are brought close to each other to fix the catcher protrusion 160.

The rollers 154 and 156 may be rotatably mounted on the roller guides 153 and 155. The rollers 154 and 156 may include a first roller 154 and a second roller 156. Specifically, the first roller 154 may be installed at the tip end of the first roller guide 153. The second roller 156 may be installed at the tip end of the second roller guide 155. The first roller 154 and the second roller 156 may face each other, and the first roller 154 and the second roller 156 may perform rolling motion in directions opposite to each other.

The rollers 154 and 156 may guide the insertion of the catcher protrusion 160 at the most rear. For example, the catcher protrusion 160 may be inserted smoothly and slidably between the first roller 154 and the second roller 156 by the rolling motion of the first roller 154 and the second roller 156.

When the catcher protrusion 160 is completely inserted by the elastic deformation of the roller guides 153 and 155, the first roller 154 and the second roller 156 may pressurize the rear end surface of the catcher protrusion 160 so as to apply opposite forces in both directions. Accordingly, the catcher protrusion 160 may be stably inserted into the catcher 150 and coupled thereto. Therefore, the user may easily fit the head bridge case 130 into the cut-out space formed in the central portion between the first head case 110 and the second head case 120.

When the head bridge case 130 is detached, the user may insert his or her fingertips into a groove thinly formed along the outline of the head bridge case 130 and pull the head bridge case 130 outward to easily remove the head bridge case 130.

Referring to FIG. 6, the driving part 300 may include a first driving case 310 that forms a first side of an appearance, a second driving case 320 that forms a second side of the appearance, and driving bridge cases 330 connecting the first driving case 310 and the second driving case 320. The first driving case 310 may form a front portion of the appearance of the driving part 300. The second driving case 320 may form a rear portion of the appearance of the driving part 300.

The first driving case 310 may be referred to as a front case of the driving part, and the second driving case 320 may be referred to as a rear case of the driving part. The first driving case 310 and the second driving case 320 may be connected to each other on a first side and a second side side of the driving part 300. For example, the first driving case 310 and the second driving case 320 may each be formed of a curved plate rounded in a semicircular shape.

The first driving case 310 and the second driving case 320 may be connected to each other such that both ends of the first driving case 310 abut both ends of the second driving case 320. Accordingly, the driving bridge cases 330 may be positioned at both side ends of the driving part 300 at which the first driving case 310 and the second driving case 320 are connected to each other.

The driving bridge cases 330 may be respectively positioned on both sides adjacent to the main wheel 301, thereby making it easy to access the motor assembly and the main wheel 301 which periodic checkup is to be taken. The first driving case 310 and the second driving case 320 may be formed such that the portions abutting each other on both sides are recessed inward. For example, the first driving case 310 and the second driving case 320 may collectively form recessed spaces which are generally circular on both sides.

The driving bridge cases 330 may be mounted in the recessed spaces formed at the portions where the first driving case 310 and the second driving case 320 abut each other. Accordingly, the driving bridge case 330 may hide the coupling portions between the first driving case 310 and the second driving case 320 so as not to be exposed to the outside.

The appearance of the driving part 300, that is, the first driving case 310, the second driving case 320, and the driving bridge cases 330 may be coupled to form an integral shape, providing a smooth outer peripheral surface. In addition, since holes or pores for fastening a plurality of components are not exposed on the outer peripheral surface of the driving part 300, the appearance may be beautiful and human-friendly.

The first driving case 310, the second driving case 320, and the head bridge case 330 may be fixed and coupled stably without a fastening hole exposed on the outer peripheral surface of the driving part 300 or a fastening member inserted into the fastening hole. Hereinafter, there will be given a description for a structure of allowing the cases 310, 320, or 330 constituting the appearance of the driving part 300 to be stably fixed and coupled to each other even when the fastening hole or fastening member causing sense of difference is not exposed on the outer peripheral surface of the driving part 300 is not exposed.

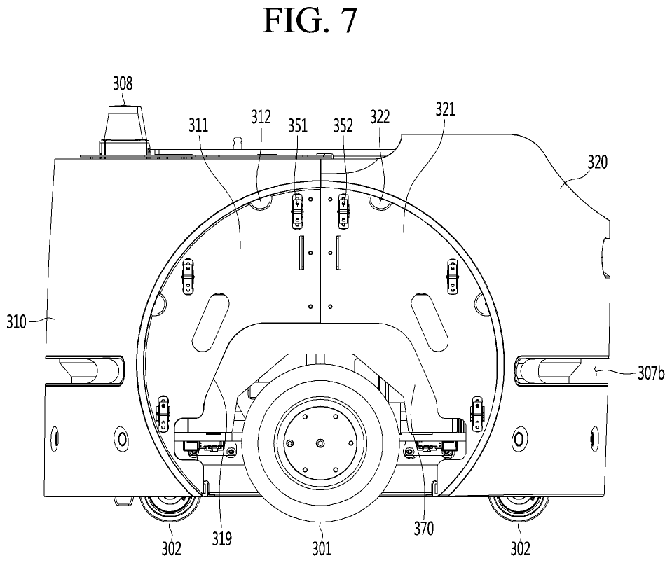

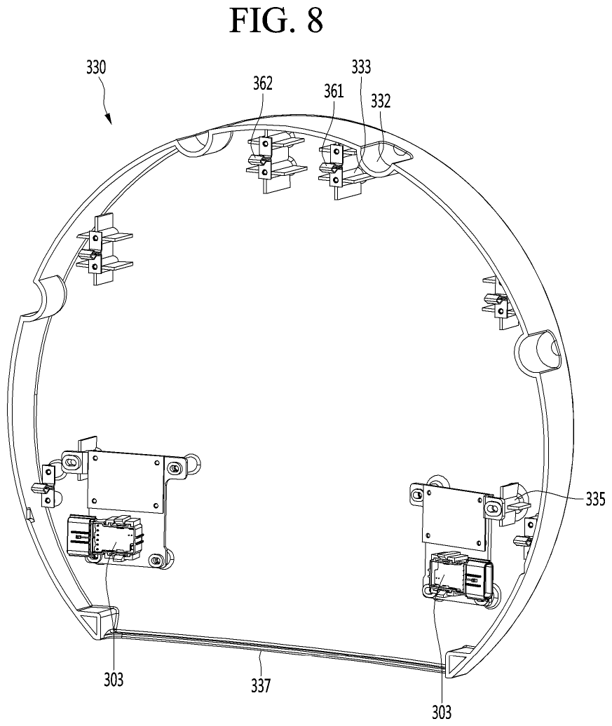

Referring to FIGS. 7 and 8, the first driving case 310 and the second driving case 320 may include recessed cases 311 and 321 such that the driving bridge cases 330 are detachably mounted. The recessed cases 311 and 321 may be recessed inward in both side portions where the first driving case 310 and the second case 320 are engaged with each other. The recessed cases 311 and 321 may be formed in a circular shape as a whole.

The first driving case 310 may include a front recessed case 311 to which one side of the driving bridge case 330 is detachably attached, and the second driving case 320 may include a rear recessed case 321 to which the other side of the driving bridge case 330 is detachably attached. The front recessed case 311 and the rear recessed case 321 may abut and be coupled to each other. Further, the front recessed case 311 and the rear recessed case 321 may form circular recessed spaces.

The driving bridge cases 330 may be inserted into and mounted in the circular recessed spaces. The first driving case 310 and the second driving case 320 may further include guide protrusions 312 and 322 that guide the attachment and detachment of the driving bridge case 330.

The first driving case 310 may further include a front guide protrusion 312 that guides the attachment and detachment of one side of the driving bridge case 330, and the second driving case 320 may further include a rear guide protrusion 322 that guides the attachment and detachment of the other side of the driving bridge case 330. The guide protrusions 312 and 322 may guide the driving bridge cases 330 to be stably inserted into the recessed space.

The guide protrusions 312 and 322 may be disposed in the outskirt of the recessed cases 311 and 321. For example, the guide protrusions 312 and 322 may protrude in a direction perpendicular to an edge stepped surface formed by the recessed cases 311 and 321. The guide protrusions 312 and 322 may be formed such that their outer surfaces are rounded.

The guide protrusions 312 and 322 may extend outward from the outer surfaces of the recessed cases 311 and 321. For example, the guide protrusions 312 and 322 may be formed as columns having a semicircular cross section. A plurality of guide protrusions 312 and 322 may be provided. The plurality of guide protrusions 312 and 322 may be spaced apart from each other at predetermined intervals along the peripheral (circumferential) direction of the recessed cases 311 and 321.

The driving bridge case 330 may include an insertion surface extending inwardly and vertically along an outer periphery and a protrusion insertion groove 332 formed to be recessed in the insertion surface. The insertion surface may be slidably inserted into the stepped surface formed along the outer peripheries of the recessed cases 311 and 321 described above.

The protrusion insertion groove 332 may be recessed downward from the insertion surface such that the guide protrusions 312 and 322 may be inserted or seated thereon. The protrusion insertion groove 332 may be formed at a position corresponding to the guide protrusion 312 or 322. As an example, a plurality of projection insertion grooves 332 may be provided spaced apart along the circumferential direction of the driving bridge case 330.

The user may slidably insert the driving bridge cases 330 into the recessed cases 311 and 321 such that the guide protrusions 312 and 322 and the protrusion insertion groove 332 correspond to each other. Therefore, the guide protrusions 312 and 322 and the projection insertion groove 332 may easily guide the coupling of the driving bridge case 330.

The driving bridge case 330 may be formed such that the lower end thereof is rounded outwardly convexly. The lower end of the driving bridge case 330 may be defined as a round portion 337.

The round portion 337 may be convex outward to guide the user so as to easily grip the driving bridge case 330. In addition, the detection sensor 303 may be installed under the inner surface of the driving bridge case 330.

The driving part 300 may further include a driving inner case 370 for managing electromagnetic interference (EMI) caused by internal electronic parts. The driving inner case 370 may be positioned inside the driving cases 310 and 320. For example, the driving inner case 370 may shield a plurality of electronic parts installed in the driving part 300.

The first driving case 310 and the second driving case 320 may be engaged with and coupled to the driving inner case 370. Specifically, the front recessed case 311 and the rear recessed case 321 may be fastened to the driving inner case 370 by fastening members. In other words, both side ends of the first driving case 310 and both side ends of the second driving case 320 may be coupled to each other to abut each other.

A plurality of fastening holes for fastening with the driving inner case 370 may be formed in the recessed cases 311 and 321 in which the first driving case 310 and the second driving case 320 abut each other, and the first driving case 310 and the second driving case 320 may be coupled and fixed by fastening members inserted into the fastening holes. The coupling portions of the first driving case 310, the second driving case 320 and the driving inner case 370 may be hid to the outside since the driving bridge case 330 is mounted outside the recessed cases 311 and 321. As a result, holes or pores for fastening are not exposed between the plurality of components in the appearance of the driving part 300.

The driving part 300 may further include a plurality of catchers (or spring clamps) 351 and 352 for guiding the attachment and detachment of the driving bridge case 330 and a plurality of catcher protrusions 361 and 362 configured to be inserted into the catchers 351 and 352. The plurality of catchers 351 and 352 may include a front catcher 351 installed in the first driving case 310 and a rear catcher 352 installed in the second driving case 320.

The plurality of catchers 351 and 352 may be spaced apart from each other on the outer surface of the recessed cases 311 and 321. The plurality of catcher protrusions 361 and 362 may include a front catcher protrusion 361 inserted into the front catcher 361 and a rear catcher protrusion 362 inserted into the rear catcher 352.

The front catcher protrusion 361 and the rear catcher protrusion 362 may be installed in a catcher guide or housing 333 extending perpendicularly from the inner surface of the driving bridge case 330. A plurality of catcher guides 333 may be spaced apart from each other in the circumferential direction so as to correspond to the plurality of catchers 351 and 352.

The catchers 351 and 352 and the catcher protrusions 361 and 362 may have the same configurations as the catcher 150 and the catcher protrusion 160 of the head part 100 described above. Therefore, the description of the catchers 351 and 352 and the catcher protrusions 361 and 362 is based on the description of the catcher 150 and the catcher protrusion 160 of the head part 100 described above. Accordingly, the user may easily fit the driving bridge case 333 into the recessed cases 311 and 321.

When the driving bridge case 330 is detached, the user may disassemble and pull the driving bridge case 330 by grasping and pulling the round portion 337 of the driving bridge case 330 in the outward direction. The first driving case 310 and the second driving case 320 may form a lower cutout 319 that is cut to facilitate access to the main wheel 301. The lower cutout 319 of the first driving case 310 and the lower cutout 319 of the second driving case 320 may be formed to be connected to each other without a step.

The lower cutout 319 may expose the main wheel 301 to the outside when the driving bridge case 330 is detached. Therefore, the lower cutout 319 may be disposed further outward than the radius of the main wheel 301. Accordingly, when the driving bridge case 330 is separated, the user may easily access and manage the main wheel 301.

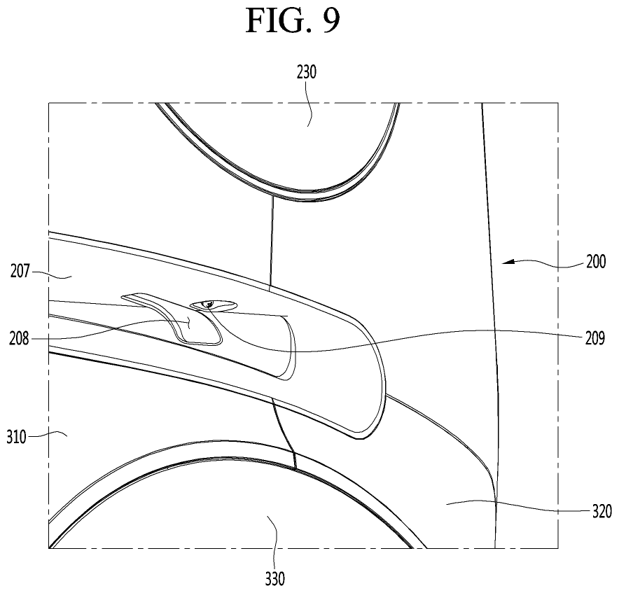

Referring to FIGS. 1 and 9, the body part 200 may include a first body case 210 forming the first side of an appearance, a second body case 220 forming the second side of the appearance, and body bridge cases 230 connecting the first body case 210 and the second body case 220. The first body case 210 may form a front portion of the appearance of the body part 200. The second body case 220 may form a rear portion of the appearance of the body part 200.

The first body case 210 may be referred to as a front case of the body part, and the second body case 220 may be referred to as a rear case of the body part. The first body case 210 and the second body case 220 may be connected to each other on a first side and a second side of the body part 200.

The first body case 210 and the second body case 220 may each be formed of a curved plate that is rounded. The first body case 210 and the second body case 220 may be connected to each other such that both ends of the first driving case 310 abut both ends of the second driving case 320. Accordingly, the body bridge cases 230 may be positioned at both side ends of the body part 200 at which the first body case 210 and the second body case 220 are connected to each other. The body bridge cases 230 may have functions and positions similar to the arms of a human body in the guide robot 1.

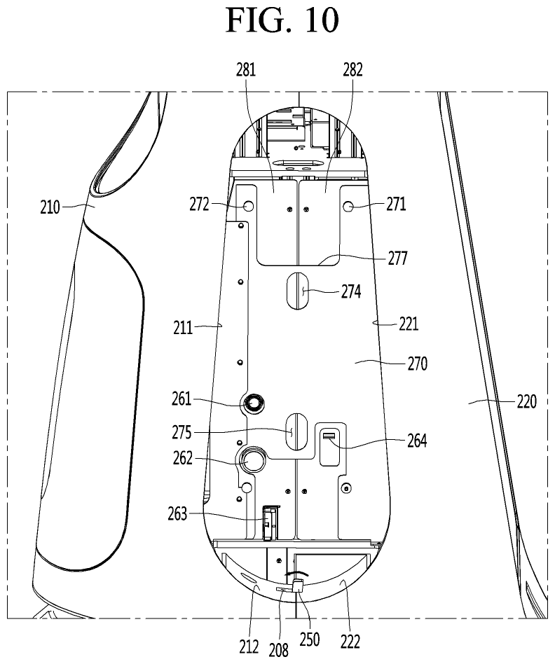

A release hole 208 may be formed in a lower cutout of the body part 200 forming the front Lidar hole 207. The release hole 208 may be an opening through which a release device 250 (see FIG. 10) is operated to detach the body bridge case 230. Therefore, the user may easily detach the body bridge case 230 from the first body case 210 and the second body case 220 by putting his/her hand into the release hole 208 and operating the release device 250.

The body part 200 may be equipped with a plurality of major electrical parts such as a communication device, a main PC, and various boards. The main electrical parts may be exposed to the outside through the body bridge case 230. Thus, the body bridge case 230 may facilitate access to the main electrical parts.

The body bridge case 230 may facilitate easy access to functional buttons that need to be urgently operated for safety. Therefore, there is an advantage that the operability of the guide robot 1 is improved.

In another aspect, when a general user using the guide robot 1 accesses the body part 200 and easily removes the body bridge case 230, another safety problem may occur. Therefore, a security screw 209 for limiting the operation of the release device 250 may be inserted into the lower cutout of the body part 200 forming the front Lidar hole 207. As an example, the security screw 209 may include a star-shaped screw.

When the security screw 209 is inserted, the release device 250 may be fixed so as not to move, so that general users may not easily put their hand into the release groove 208 and operate the release device 250. Therefore, the safety of the guide robot 1 may be improved.

The first body case 210 and the second body case 220 may be connected to each other such that they abut each other at an upper end and a lower end of both ends, respectively. The first body case 210 and the second body case 220 may form cutouts 211 and 221 that are recessed forward or backward from the upper end to the lower end, respectively.

The body bridge case 230 may be detachably installed in an open space defined by the cutouts 211 and 221. Accordingly, the body bridge case 230 may be in contact with the front cutout 211 of the first body case 210 along a first side end thereof and in contact with the rear cutout 211 of the second body case 220 along a second side end thereof. Therefore, the body bridge case 230 may be shape-engaged between the first body case 210 and the second body case 220.

The body bridge case 230 may be mounted in the cutouts 211 and 221 so that the body part 200 may have a smooth and elegant appearance in an integral shape. Accordingly, the body bridge case 330 may hide the coupling portions between the first body case 210 and the second body case 220 so as not to be exposed to the outside. The appearance of the body part 200, that is, the first body case 210, the second body case 220, and the body bridge cases 230, may be coupled to form an integral shape, providing a smooth outer peripheral surface.

Since holes or pores for fastening a plurality of components are not exposed on the outer peripheral surface of the body part 200, the appearance may be beautiful and human-friendly. The first body case 210, the second body case 220, and the body bridge case 230 may be fixed and coupled stably without a fastening hole exposed on the outer peripheral surface of the body part 200 or a fastening member inserted into the fastening hole.

Hereinafter, there will be given a description for a structure of allowing the cases 310, 320, or 330 constituting the appearance of the body part 200 to be stably fixed and coupled to each other even when the fastening hole or fastening member causing sense of difference is not exposed on the outer peripheral surface of the body part 200.

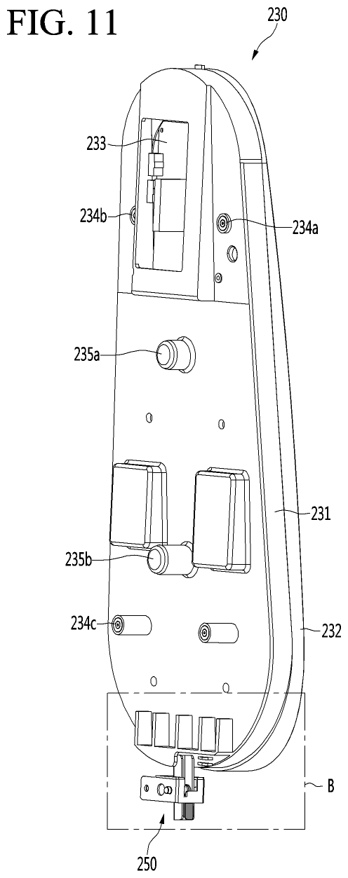

Referring to FIGS. 10 and 11, the first body case 210 and the second body case 220 may include seating portions (or seats) 212 and 222 on which the body bridge cases 230 are seated. Specifically, the first body case 210 may include a front seating portion 212 extending inward from a lower end of the front cutout 211. The second body case 220 may include a rear seating portion 222 extending inward from a lower end of the rear cutout 221.

The front seating portion 212 and the rear seating portion 222 may be connected to each other to form a single curved surface. Further, the body bridge case 230 may be seated on the curved surface. In addition, a release hole 208 for operating of the release device 250 may be formed in the seating portions 212 and 222. The release hole 208 may be a hole which is opened from the lower cutout of the body part 200 forming the front Lidar hole 207 to the seating portions 212 and 222.

As described above, the body part 200 may be equipped with a plurality of electric parts. Further, the body part 200 may include inner cases 281 and 282 for preventing electromagnetic interference (EMI) caused by the plurality of electric parts. The inner cases 281 and 282 may shield a plurality of electrical parts installed in the body 200 from the outside.

The inner cases 281 and 282 may include a front inner case 281 and a rear inner case 282. The front inner case 281 and the rear inner case 282 may be coupled to each other.

The front inner case 281 and the rear inner case 282 may surround an inner space of the body part 200 in which the plurality of electrical parts are installed. The front inner case 281 and the rear inner case 282 may be coupled to an inner frame of the body part 200.

The body part 200 may further include a body connector plate 270 coupled to outer surfaces of the inner cases 281 and 282. The body connector plate 270 may be coupled to the first body case 210 and the second body case 220. The first body case 210 and the second body case 220 may be fixed by being fastened to the body connector plate 270, respectively.

The body connector plate 270 having a plurality of fastening holes and fastening members for fixing of the first body case 210 and the second body case 220 may be hid by the body bridge case 230 so as not to be exposed to the outside. The body connector plate 270 may have a plurality of holes and latching portions for mounting the body bridge case 230. For example, the body connector plate 270 may include a latching end 277 formed to be recessed downward from an upper end, an upper hole 274 formed below the latching end 277, and a lower hole 275 formed below the upper hole 274.

The latching end 277 may receive a latching protrusion protruding from an upper portion of an inner surface of the body bridge case 230, which will be described later. An upper seating protrusion 235a and a lower seating protrusion 235b formed on the inner surface of the body bridge case 230 to be described later may be inserted into the upper hole 274 and the lower hole 275. The latching end 277, the upper hole 274 and the lower hole 275 may seat the body bridge case 230 together with the seat portions 212 and 222.

The body connector plate 270 may further include a rear magnet 271 provided at a rear end of an upper end portion and a front magnet 272 provided at a front end of the upper end portion. The front magnet 272 and the rear magnet 271 may be configured to be magnetically coupled to a front magnet device 234a and a rear magnet device 234b of the body bridge case 230 to be described later.

The installation positions of the front magnet 272 and the rear magnet 271 are not limited to the upper end portion of the body connector plate 270. The front magnet 272 and the rear magnet 271 may be installed to correspond to the front magnet device 234a and the rear magnet device 234b provided in the body bridge case 230, respectively.

As described above, the body bridge case 230 may be configured to be detached from the front cutout 211 and the rear cutout 221 so as to be easily accessible to a device to need to be urgently operated for safety and management of the guide robot 1. The body part 200 may further include a reset device or button 261 for restarting the system of the guide robot 1, a main-wheel forced driving device 262 for manually rolling the main wheel 301, an auxiliary charging terminal 263 for performing emergency charging when the guide robot 1 runs out of power and a power cutoff device 264 for cutting off all the power supplied to the guide robot 1.

The reset device 261, the main-wheel forced driving device 262, the auxiliary charging terminal 263 and the power cutoff device 264 may be disposed inside the inner cases 281 and 282. Buttons for respectively operating the reset device 261, the main-wheel forced driving device 262, the auxiliary charging terminal 263 and the power cutoff device 264 may be exposed from the body connector plate 270.

When the body bridge case 230 is detached, the reset device 261, the main-wheel forced driving device 262, the auxiliary charging terminal 263 and the power cutoff device 264 may be operated. Thus, separate disassembly is not necessary for the operation.

The body bridge case 230 may include a base plate 231 mounted in a space formed by the first body case 210 and the second body case 220, a lighting part 232 mounted along an outer periphery of the base plate 231, and a cover for protecting the lighting part 232 and the base plate 231 from the outside. The base plate 231 may have a smaller width toward an upper side. The base plate 231 may form a curved surface in which all vertexes are rounded. As an example, the base plate 231 may be formed in a roly-poly toy shape.

The base plate 231 may be inserted into the front cutout 211 and the rear cutout 221 such that an outer edge thereof is in contact with the front cutout 211 and the rear cutout 221. The base plate 231 may include a latching protrusion extending vertically inwardly from the inner surface, an upper seating protrusion 235a, and a lower seating protrusion 235b.

The latching protrusion may be seated in the latching end 277. The upper seating protrusion 235a may be inserted into the upper hole 274 and the lower seating protrusion 235b may be inserted into the lower hole 275. In addition, the base plate 231 may include a lighting control device 233 for controlling lighting of the lighting part 232.

The lighting part 232 may emit soft light from a coupling line between the first body case 210, the second body case 220, and the body bridge cases 230. The lighting part 232 may include an LED device.

The base plate 231 may include a plurality of magnet devices 234a, 234b, and 234c. The plurality of magnet devices 234a, 234b, and 234c may correspond to the plurality of magnets 271 and 272 provided in the body connector plate 270.

The plurality of magnet devices 234a, 234b, and 234c may be configured to be magnetically coupled to the plurality of magnets 271 and 272. However, the coupling of the plurality of magnet devices 234a, 234b, and 234c and the plurality of magnets 271 and 272 may be easily separated by an external force from the user.

The plurality of magnet devices 234a, 234b and 234c may include a front magnet device 234a, a rear magnet device 234b and a bottom magnet device 234c. The front magnet device 234a may be installed on a first side of an upper portion of the base plate 231. The rear magnet device 234b may be installed on a second side of the upper portion of the base plate 231.

The front magnet device 234a may be detachably coupled to the front magnet 272 and the rear magnet device 234b may be detachably coupled to the rear magnet 271. In the body part 200, the lower magnet device 234c may be installed in a lower portion of the base plate 231 to increase the fixing force of the body bridge cases 230. In this case, the magnet corresponding to the lower magnet device 234c may be installed under the body connector plate 270.

The body bridge case 230 may be configured to be detached from the space formed by the cutouts 211 and 221 by operation of the release device 250. The release device 250 for separating the body bridge case 230 will be described below in detail.

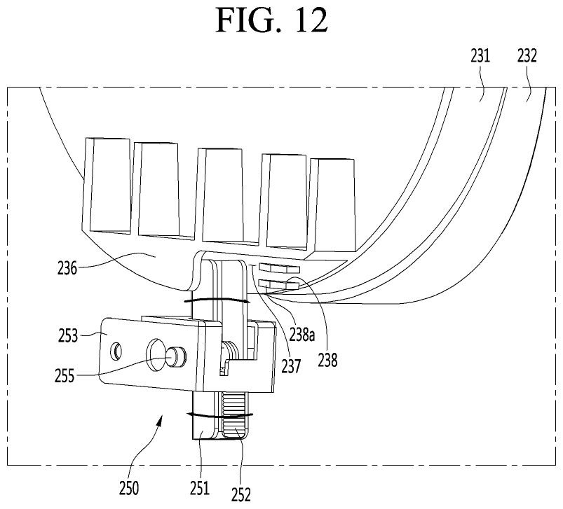

Referring to FIG. 12, the base plate 231 may further include a cover plate 236 extending inwardly from an inner surface thereof to cover an upper portion of the release device 250. The cover plate 236 may be positioned at the lower end of the base plate 231. The cover plate 236 may extend vertically from the inner surface of the base plate 231 and then be bent downward.

The cover plate 236 may form a rotating space 237 for rotation of the release device 250. The release device 250 may be rotatably positioned below the cover plate 236.

The base plate 231 may further include a release guide protrusion 238 positioned below the cover plate 236. The release guide protrusion 238 may protrude vertically from the inner surface of the base plate 231.

The release guide protrusion 237 may form a release incline 238a to have a long length extending inward from the inner surface of the base plate 231 along the rotation direction of the release device 250. The release incline surface 238a may be formed to have a long length extending inward toward the extending direction of the release guide protrusion 238.

Further, the release incline surface 238a may contact the release shaft 251 of the discharge device 250 when the release shaft 251 is rotated. Accordingly, a force pushing outwardly by the release shaft 251 may be transferred through the release incline surface 238a.

The release device 250 may be installed in the first body case 210 or the second body case 220. The release device 250 may include a release bracket 253 coupled to the inner surface of the first body case 210 or the second body case 220 and a shaft axis (or pivot shaft) 255 coupled to pass through the release bracket 253, a release shaft 251 rotatably coupled to the shaft axis 255, and a push button 252 coupled to a lower end of the release shaft 251 to guide the user's pressing.

The release bracket 253 may be coupled to the inner surfaces of the body cases 210 and 220. For example, the release bracket 253 may be coupled and fixed to the inner surface of the second body case 220. The release bracket 253 may be opened in the vertical direction.

The shaft axis 255 may pass through the release bracket 253 laterally. The shaft axis 255 may define a rotation or pivot axis of the release shaft 251. The shaft axis 255 may pass through the release shaft 251. Therefore, the release shaft 251 may be rotated about the shaft axis 255.

The release shaft 251 may elongate in the vertical direction. The release shaft 251 may have a recessed portion that is recessed inward, and the push button 252 may be installed in the recessed portion. The push button 252 may be coupled to the lower end of the release shaft 251. The user may press the push button 252 by putting his/her hand through the release hole 208.

The release shaft 251 may be rotated about the shaft axis 255 passing through the center thereof by the force with which the user presses the push button 252. For example, the push button 252 may be pushed rearward so that the upper end of the release shaft 251 rotates forward.

In this case, the upper end of the release shaft 251 may be brought in contact with the release guide protrusion 238 to transfer the force to the base plate 231. The release shaft 251 may be brought into contact with the release incline surface 238a and move along the release incline surface 238a. Since the release incline surface 238a may have a long length extending in the rotation direction of the release shaft 251, the release shaft 251 may provide a force to push the base plate 231 outward.

The body bridge case 230 may be pushed outward from the cutouts 211 and 221 formed by the first body case 210 and the second body case 220 by the release shaft 251 that rotates along the release guide protrusion 238. Thus, the user may grip a protruding lower end of the body bridge case 230 by hand, and apply an external force toward the outside of the body bridge case 230. Accordingly, the coupling between the plurality of magnet devices 234 and the plurality of magnets 271 and 272 may be released, thereby completely separating the body bridge case 230.

The head bridge case 130, the body bridge case 230, and the driving bridge case 330 may be collectively referred to as a bridge case 130, 230, or 330. The first head case 110, the first body case 210, and the first driving case 310 may be referred to as a first case of the guide robot 1.

Similarly, the second head case 120, the second body case 220, and the second driving case 320 may be referred to as a second case of the guide robot 1. The bridge case may be detachably attached to the coupling portion between the first case and the second case, and may prevent a plurality of fastening holes and fastening members formed for coupling of the first case and the second case from being exposed to the outside.

The appearance structure causing a sense of heterogeneity to a user such as a fastening hole may be hidden inside, and therefore, the sense of heterogeneity may be minimized and the robot design may be human-friendly. The use of the outer and inner cases also has the advantage of being able to meet water, dust and electromagnetic interference (EMI) standards and to improve accessibility for management.

In addition, necessary parts that are scheduled to be periodically replaced for maintenance or to be checked may be provided in close proximity so as to be easily accessible, and the structure for enhancing the accessibility of the necessary parts may be provided, thereby improving manageability and convenience. Further, since the bridge case structure that is easy to assemble or disassemble is provided, unnecessary disassembly or disassembly work is prevented, and workability and usability are improved.

Further, since the operation buttons for managing the guide robot is easily accessed, there is an advantage that an efficient management work can be performed. In addition, since a safety device is provided to prevent a general person other than the manager from operating the main operation buttons of the guide robot, security is improved.

In addition, various operation devices for preventing a user's safety accident are provided, thereby improving safety of the guide robot. In addition, there is an advantage that the appearance is excellent and the intimacy of the user with respect to the product can be enhanced.

An object of the present disclosure is to provide a guide robot capable of improving manageability such as repair, replacement of parts, and transportation while maintaining a beautiful design. Another object of the present disclosure is to provide a guide robot capable of complying with waterproof, dustproof and electromagnetic interference (EMI) standards and improving accessibility to necessary parts.

Still another object of the present disclosure is to provide a guide robot capable of solving the problem of causing a user to feel heterogeneity due to various fastening holes exposed to the outside. Still another object of the present disclosure is to provide a human-friendly and ergonomic guide robot. Still another object of the present disclosure is to provide a guide robot capable of preventing the risk of a safety accident.

A guide robot may include a driving part configured to provide a traveling function, a body part disposed above the driving part, and a head part disposed above the body part, wherein the driving part, the body part, and the head part include a first case configured to form one face of an appearance, a second case configured to form the other face of the appearance, and a bridge case inserted at a point where the first case and the second case are coupled to each other.

The guide robot may further include an inner case configured to shield a plurality of electronic parts provided in the inner case. The first case and the second case may be fastened and fixed to the inner case.

The bridge case may be configured to cover a plurality of fastening holes formed in the first case and the second case to be fastened to the inner case. The bridge case may be detachably inserted into a cutout formed by the first case and the second case.

The first case may include a first head case forming an appearance of one side of the head part, a first body case forming a front appearance of the body part, and a first driving case forming a front appearance of the driving part. The second case may include a second head case forming an appearance of the other side of the head part, a second body case forming a rear appearance of the body part, and a second driving case forming a rear appearance of the driving part.

The bridge case may include a head bridge case inserted into a center space formed by cutting the first head case and the second head case. The head part may include a plurality of inner cases for shielding a plurality of electronic parts installed in an inner space of the head part.

The head part may include catchers installed in the plurality of inner cases and catcher protrusions installed in the head bridge case, the catcher protrusions being inserted into the catchers. The head bridge case may be detached or attached by the catchers and the catcher projections.

The bridge case may include a driving bridge case inserted into a recessed space formed by the first driving case and the second driving case. The driving part may include a recessed case defining the recessed space, a catcher installed in the recessed space, and a catcher protrusion installed in the driving bridge case and inserted into the catcher.

The driving part may further include a main wheel configured to perform rolling motion, and wherein an lower end of the recessed case is cut such that the main wheel is exposed. The driving part may further include a driving inner case configured to shield a plurality of electronic parts installed in an inner space of the driving part.

The recessed case may be fastened to the driving inner case. The first driving case and the second driving case may include a guide protrusion configured to guide engagement of the driving bridge case. The bridge case may include a protrusion insertion groove formed to be recessed to correspond to the guide protrusion.

The driving bridge case may have a lower end formed to be rounded outward convexly. The bridge case may include body bridge cases inserted into both side spaces formed by cutting the first body case and the second body case.

The body part may further include a release device coupled to the first case or the second case to guide separation of the bridge case. The release device may be operated by a release hole formed in a lower end of the body part.

The release device may be rotatably disposed in a lower portion of the body bridge case. The release device may push the body bridge case outward by being pivoted. The first body case and the second body case may form a seating surface on which the body bridge case is seated.

The body bridge case may include a base plate, a lighting part coupled along an outer periphery of the base plate to provide light, and a cover configured to cover the base plate and the lighting part from outside. The base plate may be provided with a lighting control device for controlling the lighting part.

The head part may be provided with an emergency button for enabling emergency braking. The body part may include a display part embedded in a rear surface. The display part may include a barcode reader for recognizing a barcode.

The body part may include a reset device configured to restart a system, and a power cut-off device configured to cut off provided power. It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the disclosure are described herein with reference to cross-section illustrations that are schematic illustrations of idealized embodiments (and intermediate structures) of the disclosure. As such, variations from the shapes of the illustrations as a result, for example, of manufacturing techniques and/or tolerances, are to be expected. Thus, embodiments of the disclosure should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A guide robot comprising:
A base including a driving component of the robot;
a body provided on an upper portion of the base; and
a head provided on an upper portion of the body,
wherein each of the base, the body, and the head include:
a first case configured to form a first face of the guide robot;
a second case attached to the first case and configured to form a second face of the guide robot; and
a bridge case configured to cover an opening formed between the first and second cases.

2. The guide robot of claim 1, wherein each of the base, the body, and the head further comprises an inner case configured to shield a plurality of electronic parts provided in the inner case.

3. The guide robot of claim 2, wherein the first case and the second case are fastened to each other and fixed to the inner case for each of the base, the body, and the head.

4. The guide robot of claim 2, wherein the bridge case is configured to cover a plurality of fastening holes formed in the first case and the second case to be fastened to the inner case.

5. The guide robot of claim 1, wherein the bridge case is detachably inserted into the opening formed by the first case and the second case.

6. The guide robot of claim 1, wherein the first case includes:
a first head case that forms a first side of the head;
a first body case that forms a front of the body; and
a first base case that forms a front of the base.

7. The guide robot of claim 6, wherein the second case includes:
a second head case that forms a second side of the head;
a second body case that forms a rear of the body; and
a second base case that forms a rear of the base.

8. The guide robot of claim 7, wherein the bridge case includes a head bridge case configured to be inserted into the opening formed between the first head case and the second head case.

9. The guide robot of claim 8, wherein the head includes:
a plurality of inner cases that shield a plurality of electronic parts installed in an inner space of the head;
a plurality of catches installed in the plurality of inner cases; and
a plurality of strikes installed in the head bridge case, wherein the plurality of strikes are configured to be inserted into the plurality of catches.

10. The guide robot of claim 9, wherein the head bridge case is detached from or attached to the head by the plurality of catches and the plurality of strikes.

11. The guide robot of claim 7, wherein the bridge case includes a base bridge case configured to be inserted into a groove formed at a portion of the junction of the first driving case and the second driving case.

12. The guide robot of claim 11, wherein the base includes:
a recessed case that defines the groove;
a catch installed in the groove; and
a strike installed in the base bridge case and configured to be inserted into the catch.

13. The guide robot of claim 12, wherein the base further includes a base inner case configured to shield a plurality of electronic parts installed in an inner space of the base, wherein the recessed case is fastened to the base inner case.

14. The guide robot of claim 11, wherein the first base case and the second base case each include a guide protrusion configured to guide attachment of the base bridge case, wherein the base bridge case includes a protrusion insertion groove that corresponds to the guide protrusion of the first base case and a protrusion insertion groove that corresponds to the guide protrusion of the second base case.

15. The guide robot of claim 11, wherein a lower end of the base bridge case defines a round portion that extends convexly to allow a user's hand to be inserted therein.

16. The guide robot of claim 7, wherein the bridge case includes body bridge cases configured to be inserted into the openings respectively formed between the first body case and the second body case on both a first side and a second side of the guide robot.

17. The guide robot of claim 16, wherein the body further includes a release lever coupled to the first body case or the second body case to guide a separation of the body bridge case.

18. The guide robot of claim 17, wherein the release lever is configured to contact the body bridge case and push the body bridge case outward when the release lever is pressed.

19. The guide robot of claim 16, wherein the body bridge case includes:
a base plate;
a light provided along an outer periphery of the base plate; and
a cover plate configured to cover the base plate and the light,
wherein the base plate includes a light control device that controls the light.

20. The guide robot of claim 1, wherein the head includes an emergency button configured to initiate an application of an emergency brake, and wherein the body includes:
a display embedded in one of the first and second body cases;
a reset device configured to restart a system; and
a power cut-off device configured to cut off power to the system.
